(19) United States
(12) Patent Application Publication
(10) Pub. No.: US 2012/0239712 A1
(43) Pub. Date: Sep. 20, 2012

(54) METHOD AND APPARATUS FOR CONSTRUCTING AND PLAYING SENSORY EFFECT MEDIA INTEGRATION DATA FILES

(75) Inventors: Gun-Ill Lee, Seoul (KR); Kwang-Cheol Choi, Gwacheon-si (KR); Jae-Yeon Song, Seoul (KR); Seo-Young Hwang, Suwon-si (KR)

(73) Assignee: Samsung Electronics Co., Ltd., Suwon-si (KR)

(21) Appl. No.: 13/422,964

(22) Filed: Mar. 16, 2012

(30) Foreign Application Priority Data
Mar. 17, 2011 (KR) 10-2011-0024064

(51) Int. Cl. G06F 17/30

(52) U.S. Cl. 707/821; 707/E17.01

(57) ABSTRACT

A method and apparatus for constructing and playing a sensory effect media integration data file in which media type information indicating a type of media data and a sensory effect indicator configured to indicate whether sensory effect information is included or not are inserted in a file type field, configuration information representing an attribute of at least one media data is inserted in a configuration information container field, a coded stream of the media data is inserted in a media data container field, and the sensory effect information is inserted in one of the file type field and the configuration information container field according to a relationship between sensory effects and the media data.

### CROSS-REFERENCE TO RELATED APPLICATION(S) AND CLAIM OF PRIORITY

The present application is related to and claims priority under 35 U.S.C. §119(a) to a Korean Patent Application filed in the Korean Intellectual Property Office on Mar. 17, 2011 and assigned Serial No. 10-2011-0024064, the contents of which are incorporated herein by reference.

### TECHNICAL FIELD OF THE INVENTION

The present invention relates to media data processing devices, and more particularly, to a method and apparatus for constructing and playing sensory effect media integration files.

### BACKGROUND OF THE INVENTION

Typically, a medial file format is divided into a header part that describes information about media and a video data part that includes compressed media data. Although the typical media file format can be used to store simple video data, it may not be well suited as a comprehensive structure for including various types of media.

In this context, the Moving Picture Experts Group (MPEG), an international standardization organization has defined a basic file format commonly applicable to a variety of applications, called the International Organization for Standardization (ISO) Base Media File Format. The ISO Base Media File Format was designed to hierarchically store data such as compressed media streams and configuration information associated with the compressed media streams in multiple containers. The ISO Base Media File Format is not necessarily a definition of a coding and decoding scheme. Rather, it defines a basic structure for efficiently storing coded or decoded media streams.

The development of digital technology and network transmission technology has been a driving force behind the emergence of new, various multimedia services. As a delineation between independently developed broadcasting and communication areas has converged in the 2000's, broadcasting-communication convergence services have emerged, making relatively good use of the advantages of broadcasting and communication. Along with the emergence of such new applications, interest has been attracted to multimedia quality enhancement that stimulates human senses such that extensive research on sensory effect media technology has been underway. Sensory effect media is generally an integrated representation of various types of component media information that creates a sense of reality and a sense of immersion in a virtual environment, that in many cases, goes beyond temporal and spatial limitations of conventional forms. A sensory effect media service is realized through creation, processing, storage, transmission, and representation of multi-dimensional information including visual, auditory, and tactile information.

The afore-described MPEG standard generally defines an interface standard for communication between virtual worlds and between a virtual world and a real world through the MPEG-V (ISO/IEC 23005) project. Objects of which the standardization the MPEG is working on cover a broad range including representation of sensory effects such as wind, temperature, vibration, etc. and description of control commands for interaction between a virtual world and a device.

However, a sensory effect media file for creating a sense of reality and a sense of immersion may be constructed as an independent file that describes metadata having sensory effect information in eXtensible Markup Language (XML), in addition to conventional media content. A data file format for providing media data and sensory effect information in one integrated file is yet to be specified for standardization.

### SUMMARY OF THE INVENTION

To address the above-discussed deficiencies of the prior art, it is a primary object to provide some, none, or all of the advantages described below. Accordingly, an aspect of certain embodiments of the present invention is to provide an apparatus and method for generating a data storing format that stores sensory effect media integration data that are compatible with the ISO Base Media File Format.

Another aspect of certain embodiments of the present invention is to provide an apparatus and method for playing sensory effect media integration data stored in a format compatible with an international standard format, such as the ISO Base Media File Format.

In accordance with an embodiment of the present invention, a method for constructing a sensory effect media integration data file includes, inserting media type information indicating a type of media data and a sensory effect indicator indicating whether sensory effect information is included or not are inserted in a file type field, configuration information representing an attribute of at least one media data is inserted in a configuration information container field, inserting a coded stream of the media data in a media data container field, and inserting the sensory effect information in one of the file type field and the configuration information container field according to a relationship between sensory effects and the media data.

In accordance with another embodiment of the present invention, an apparatus for constructing a sensory effect media integration data file includes a file type information configurer configured to configure file type information by detecting information about a file type of a sensory effect media integration data file from received media data, a configuration information configurer configured to detect information about an attribute of the media data from the received media data and configure configuration information representing the attribute of the media data, a coded stream configurer configured to detect a coded stream of the media data from the received media data and configure the coded stream of the media data, a sensory effect type detector configured to transmit sensory effect information to one of the file type information configurer and the configuration information configurer according to a relationship between received sensory effects and the media data, and a sensory effect media integration data file generator configured to generate a sensory effect media integration data file by combining the file type information, the configuration information, and the coded stream.

In accordance with another embodiment of the present invention, a method for playing a sensory effect media integration data file includes, separating in a file type field, a configuration information container field, and a media data container file from the sensory effect media integration data file, detecting media type information indicating a media type and a sensory effect indicator indicating whether sensory effect information by parsing the file type field, detecting configuration information about an attribute of media data by parsing the configuration information container field, detecting a coded stream of the media data by parsing the media data container field, playing the media data by combining the media type information, detecting the sensory effect indicator, the configuration information, the coded stream, and the sensory effect information from the file type field or the configuration information container field according to a relationship between sensory effects and the media data, and sensory effects corresponding to the played media data are generated.

In accordance with a further embodiment of the present invention, an apparatus for playing a sensory effect media integration data file includes a sensory effect media integration data file separator configured to separate a file type field, a configuration information container field, and a media data container file from the sensory effect media integration data file, a file type information parser configured to detect media type information indicating a media type and a sensory effect indicator indicating whether sensory effect information is included by parsing the file type field, a configuration information parser configured to detect configuration information about an attribute of media data by parsing the configuration information container field, a coded stream parser configured to detect a coded stream of the media data by parsing the media data container field, a media data player configured to play the media data by combining the media type information, the sensory effect indicator, the configuration information, and the coded stream, and a sensory effect generator configured to receive sensory effect information detected from the file type field by the file type information parser or sensory effect information detected from the configuration information container field by the configuration information parser and generate sensory effects corresponding to the played media data.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example apparatus for constructing sensory effect media integration data according to an embodiment of the present invention;

FIG. 2 illustrates an example description of sensory device capabilities included in sensory effect information, used in the apparatus for constructing sensory effect media integration data according to the embodiment of the present invention;

FIG. 3 illustrates an example description of user sensory preferences used in the apparatus for constructing sensory effect media integration data according to the embodiment of the present invention;

FIG. 4 illustrates an example description of sensory device commands for use in the apparatus for constructing sensory effect media integration data according to the embodiment of the present invention;

FIG. 5 illustrates an example description of information sensed by a sensor, used in the apparatus for constructing sensory effect media integration data according to the embodiment of the present invention;

FIG. 6 illustrates an example file type box generated in the apparatus for constructing sensory effect media integration data according to the embodiment of the present invention;

FIGS. 7A, 7B and 7C illustrate example sensory effect media integration data files generated in the apparatus for constructing sensory effect media integration data according to the embodiment of the present invention;

FIG. 8 illustrates an example method for constructing a sensory effect media integration data file according to an embodiment of the present invention;

FIG. 9 illustrates an example apparatus for playing sensory effect media integration data according to an embodiment of the present invention; and

FIG. 10 illustrates an example method for playing a sensory effect media integration data file according to an embodiment of the present invention.

Throughout the drawings, the same drawing reference numerals will be understood to refer to the same elements, features and structures.

### DETAILED DESCRIPTION OF THE INVENTION

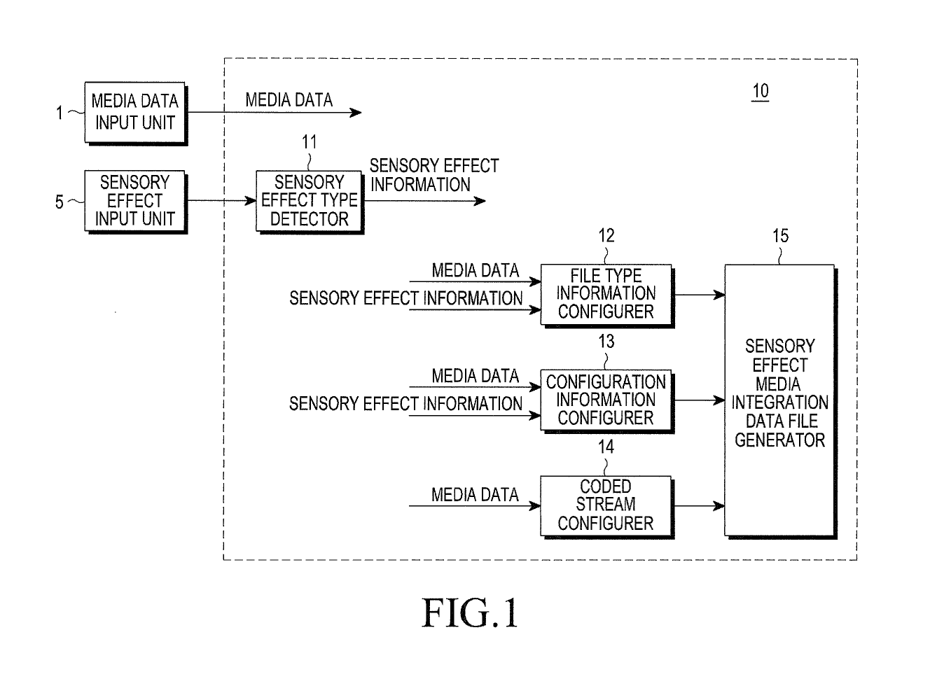

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged media processing devices. Reference will be made to the preferred embodiment of the present invention with reference to the attached drawings. While the following description includes specific details, it is to be clearly understood to those skilled in the art that the specific details are provided to help comprehensive understanding of the present invention and modifications and variations can be made to them within the scope and spirit of the present invention.

FIG. 1 illustrates an example apparatus for constructing sensory effect media integration data according to an embodiment of the present invention. Referring to FIG. 1, an apparatus 10 for constructing sensory effect media integration data is connected to a media data input unit 1 for inputting media data and a sensory effect input unit 5 for inputting sensory effect information. The apparatus 10 receives media data from the media data input unit 1 and sensory effect information from the sensory effect input unit 5. To create a sensory effect media integration data file by combining the media data with the sensory effect information, the apparatus 10 includes a sensory effect type detector 11, a file type information configurer 12, a configuration information configurer 13, a coded stream configurer 14, and a sensory effect media integration data file generator 15.

The media data received from the media data input unit 1 is provided to the file type information configurer 12, the configuration information configurer 13, and the coded stream configurer 14, and the sensory effect information received from the sensory effect input unit 5 is provided to the sensory effect type detector 11.

The media data may include video data, audio data, and/or text data. The media data may be a combination of one or more of the video data, audio data, and text data. The video data may include 3-dimensional (3D) data such as a stereoscopic image.

The sensory effect information refers to information that may give visual, auditory, and tactile stimuli to a media data user. The sensory effect information may be information that can represent light, flash, heating, cooling, wind, vibration, scent, fog, spraying, color correction, tactile sensation, kinesthetic sensation, a rigid body motion, and the like.

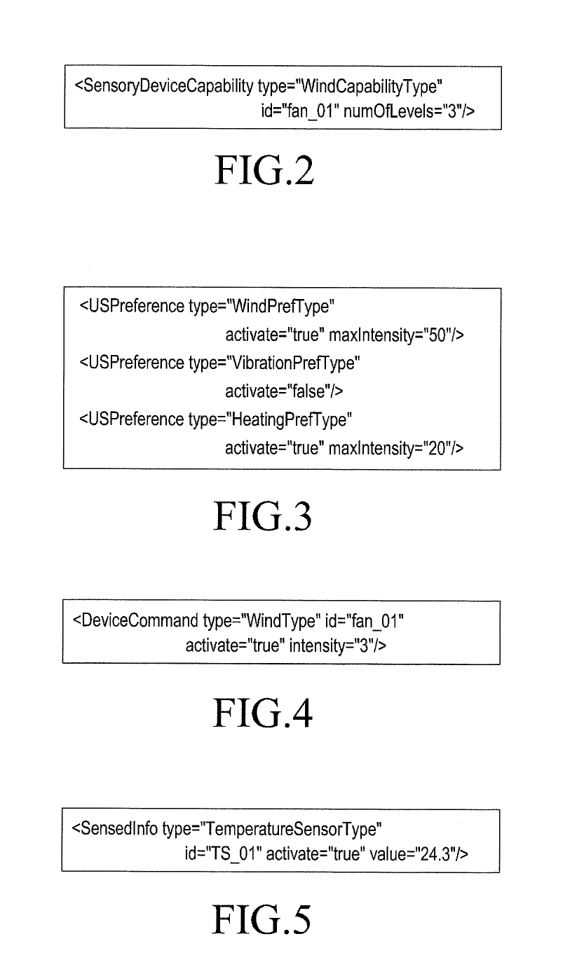

Further, the sensory effect information may include metadata described in ISO/IEC 23005-1, ISO/IEC 23005-2, ISO/IEC 23005-3, ISO/IEC 23005-4, ISO/IEC 23005-5, and ISO/IEC 23005-6 as defined in MPEG-V(ISO/IEC 23005) of the major international standardization organization on multimedia content, such as defined in the MPEG standard. For example, the metadata may include sensory effect information metadata, sensory device capabilities metadata, user sensory preferences metadata, sensory device commands metadata, virtual world object information metadata, and sensor information for context aware metadata. Specifically, the sensory device capabilities metadata, the user sensory preferences metadata, and the sensory device commands metadata, and sensed information metadata may be described as illustrated in FIGS. 2 to 5, respectively, as described in detail below.

The sensory effect type detector 11 determines whether the received sensory effect information is associated with a whole file or the media data. If the sensory effect information is associated with the whole file, the sensory effect type detector 11 provides the sensory effect information to the file type information configurer 12. If the sensory effect information is associated with the media data, the sensory effect type detector 11 provides the sensory effect information to the configuration information configurer 13.

If the sensory effect information describes sensory effects related to the media data, the sensory effects may be associated with all media objects included in the media data or only at least one of the media objects. Accordingly, the sensory effect type detector 11 may further transmit information indicating whether the sensory effects are associated with all or only at least one of the media objects included in the media data.

Further, when transmitting the sensory effect information to the file type information configurer 12 or the configuration information configurer 13, the sensory effect type detector 11 may generate a sensory effect type indicator indicating whether the sensory effect information describes sensory effects related to the entire file, all media objects included in the media data, or at least one specified media object included in the media data, and may transmit the sensory effect type indicator along with the sensory effect information to the file type information configurer 12 or the configuration information configurer 13. If the sensory effects are confined to at least one specific media object included in the media data, the sensory effect type detector 11 may further transmit an Identifier (ID) that identifies the specific media object.

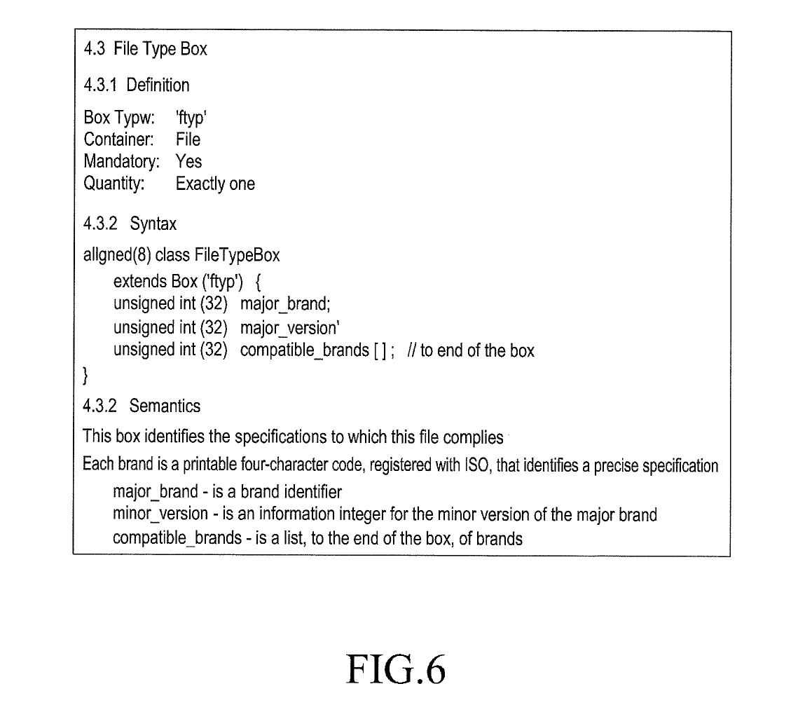

The file type information configurer 12 configures file type information by detecting information related to the file type of a media integration data file from the media data or the sensory effect information. For example, the file type information configurer 12 determines whether the media data is general media data (i.e. video data and/or audio data) or media data that can be played in conjunction with sensory effect information and configures a file type field including the file type information, as illustrated in FIG. 6. Referring to FIG. 6, if the media data can be played in conjunction with the sensory effect information, major_brand may be set to rmf1 in a fytp box of the file type field.

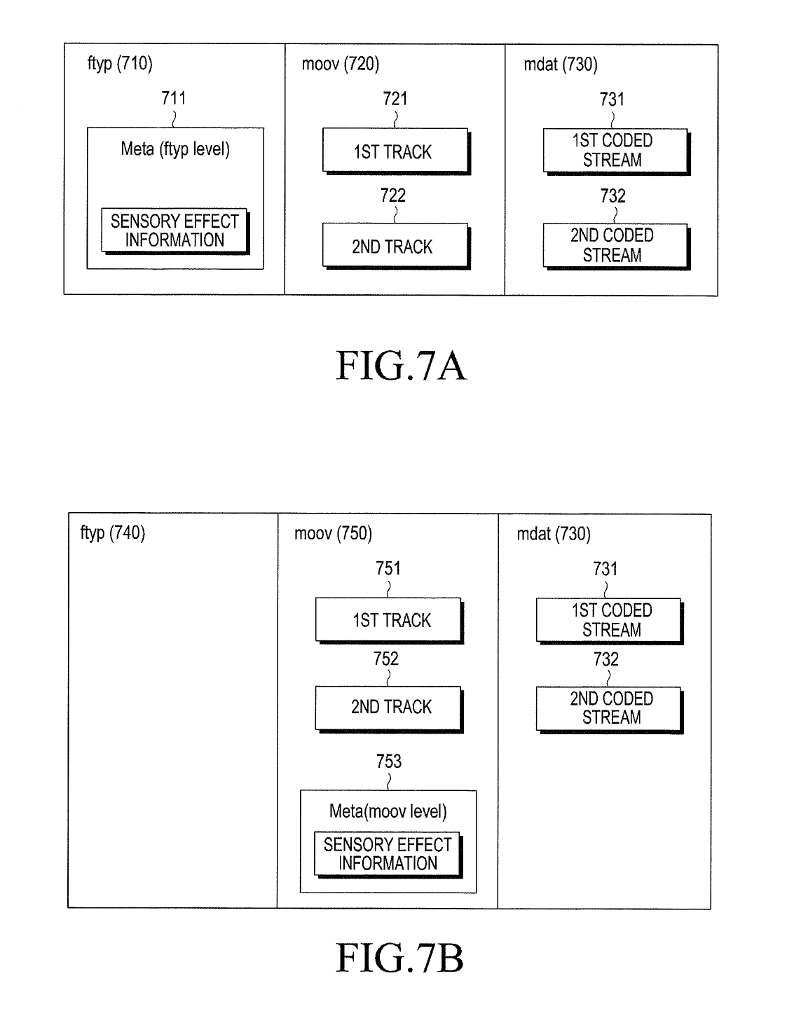

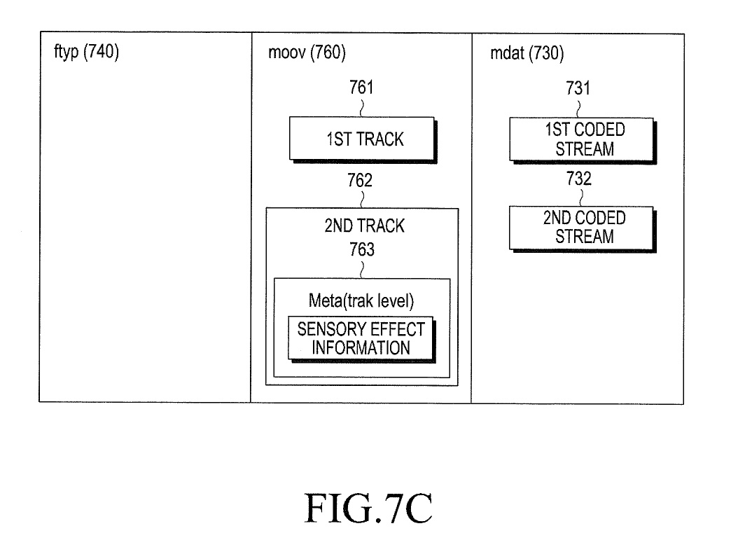

Referring again to FIG. 1, the file type information configurer 12 may identify the sensory effect type indicator received from the sensory effect type detector 11. If the sensory effect type indicator indicates that the sensory effect information describes sensory effects associated with the entire file, the file type information configurer 12 may insert a metadata box 711 that defines sensory effect information into a file type field 710 as illustrated in FIG. 7A.

The configuration information configurer 13 detects information about the media objects included in the media data from the received media data and configures configuration information about each media object. More specifically, the configuration information configurer 13 may configure configuration information including information about the size of video data included in the media data, information defining the type of coded streams of the media data, information about a camera that captured images, display information used to display images, information about the frame rate of the video data, and information about the number of field lines of a frame in the video data. If the media data includes a 3D image, the configuration information configurer 13 may further include information about the disparity between the left and right images of the 3D image.

The configuration information configurer 13 may identify the sensory effect type indicator received from the sensory effect type detector 11. If the sensory effect type indicator indicates that the sensory effect information describes sensory effects associated with all media objects included in the media data, the file configuration information configurer 13 may insert a metadata insert a box 753 that defines the sensory effect information into a configuration information container field 750 as illustrated in FIG. 7B. If the sensory effect type indicator indicates that the sensory effect information describes sensory effects associated with at least one specific media object included in the media data, the configuration information configurer 13 may insert a metadata box 763 that defines the sensory effect information into a media track box 762 corresponding to the specific media object as illustrated in FIG. 7C.

Referring again to FIG. 1, the coded stream configurer 14 stores coded streams of the media objects included in the media data in correspondence with configuration information tracks generated on a media object basis by the configuration information configurer 13. Therefore, the number of the coded streams may be equal to the number of the configuration information tracks.

The sensory effect media integration data file generator generates a sensory effect media integration data file by combining the file type information received from the file type information configurer 12, the configuration information received from the configuration information configurer 13, and the coded streams received from the coded stream configurer 14.

Especially, the sensory effect media integration data file configurer 15 may detect the sensory effect type indicator received from the sensory effect type detector 11 and configure the sensory effect media integration data file according to the sensory effect type indicator.

For example, if the sensory effect type indicator indicates that the sensory effect information describes sensory effects associated with the whole file, the sensory effect media integration data file generator 15 receives the file type field 710 (FIG. 7A) having the metadata box 711 defining the sensory effect information inserted in it from the file type information configurer 12, receives the configuration information container field 720 having first and second tracks 721 and 722 including configuration information about first and second media objects, respectively, inserted in it from the configuration information configurer 13, and receives a media data container field 730 having a first coded stream track 731 with a coded stream of the first media object and a second coded stream track 732 with a coded stream of the second media object from the coded stream configurer 14. Next, the sensory effect media integration data file configurer 15 generates a sensory effect media integration data file including the file type field 710, the configuration information container field 720, and the media data container field 730, and outputs the sensory effect media integration data file.

If the sensory effect type indicator indicates that the sensory effect information describes sensory effects associated with all media objects included in the media data, the sensory effect media integration data file generator 15 receives a file type field 740 (FIG. 7B) having file type information inserted in it from the file type information configurer 12, receives a configuration information container field 750 having first and second tracks 751 and 752 including configuration information about the first and second media objects, respectively, and the metadata box 753 defining the sensory effect information from the configuration information configurer 13, and receives the media data container field 730 having the first coded stream track 731 with the coded stream of the first media object and the second coded stream track 732 with the coded stream of the second media object from the coded stream configurer 14. Next, the sensory effect media integration data file generator 15 generates a sensory effect media integration data file including the file type field 740, the configuration information container field 750, and the media data container field 730, and outputs the sensory effect media integration data file.

If the sensory effect type indicator indicates that the sensory effect information describes sensory effects associated with at least one media object included in the media data, the sensory effect media integration data file generator 15 receives the file type field 740 (FIG. 7C) having the file type information inserted in it from the file type information configurer 12, receives a configuration information container field 760 having a first track 761 with configuration information about the first media object and a second track 762 with configuration information about the second media object and a metadata box 763 including the sensory effect information from the configuration information configurer 13, and receives the media data container field 730 having the first coded stream track 731 with the coded stream of the first media object and a second coded stream track 732 with the coded stream of the second media object from the coded stream configurer 14. Then the sensory effect media integration data file configurer 15 generates a sensory effect media integration data file including the file type field 740, the configuration information container field 760, and the media data container field 730, and outputs the sensory effect media integration data file.

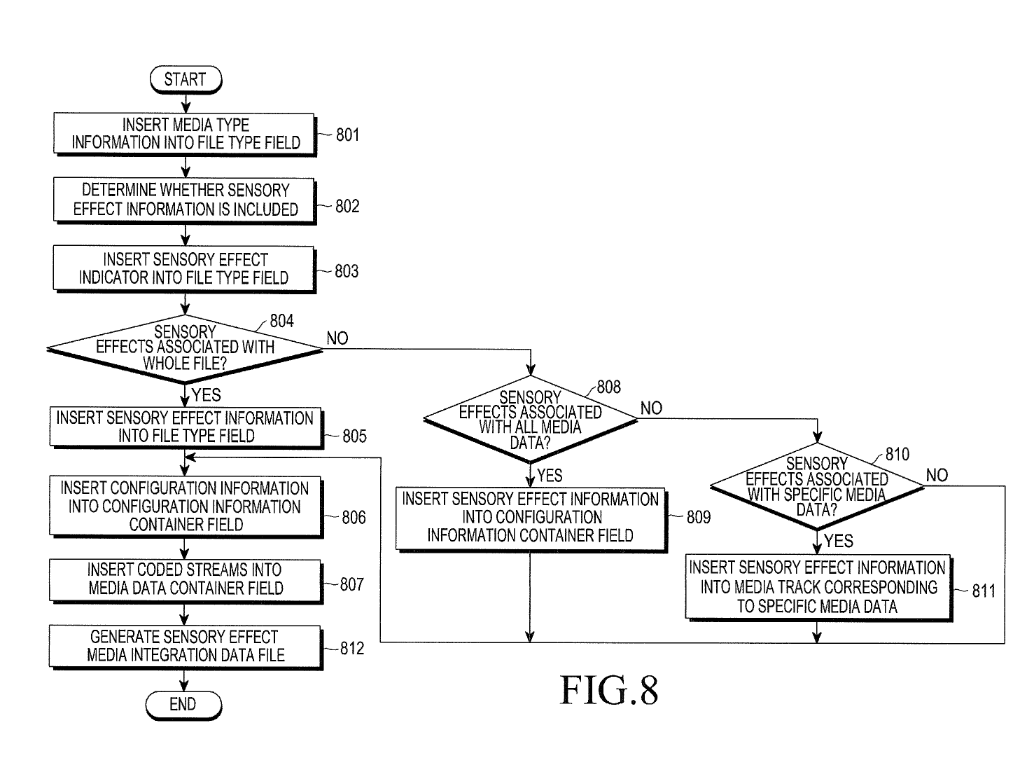

FIG. 8 illustrates an example method for constructing a sensory effect media integration data file according to an embodiment of the present invention.

The operations of the afore-described components will be described by describing the sequential steps of the method for constructing sensory effect media integration data according to the embodiment of the present invention with reference to FIG. 8.

Referring to FIG. 8, the file type information configurer 12 detects information about the file type of a media integration data file from received media data and inserts file type information into a file type field in step 801.

In step 802, the file type information configurer 12 determines whether the media data is general media data (i.e. video data and/or audio data) or the media data can be played in conjunction with sensory effect information. The file type information configurer 12 sets a sensory effect indicator according to the determination and configures the file type field to include the sensory effect indicator as illustrated in FIG. 6 in step 803. For example, if the media data can be played in conjunction with sensory effect information, major_brand may be set to rmf1.

In step 804, the sensory effect type detector 11 determines whether the sensory effect information describes sensory effects associated with the whole file or the media data. If the sensory effect information describes sensory effects associated with the whole file in step 804, the sensory effect type detector transmits the sensory effect information to the file type information configurer 12. The sensory effect type detector 11 may transmit a sensory effect type indicator together with the sensory effect information to the file type information configurer 12.

The file type information configurer 12 may identify the sensory effect type indicator received from the sensory effect type detector 11. If the sensory effect type indicator indicates that the sensory effect information describes sensory effects associated with the whole file, the file type information configurer 12 inserts the metadata box 711 that defines the sensory effect information into the file type field 710 as illustrated in FIG. 7A in step 805.

In step 806, the configuration information configurer 13 detects information about media objects included in the media data from the media data and configures configuration information about each media object. The be more specific, the configuration information configurer 13 may configure configuration information including information about the size of video data included in the media data, information defining the type of coded streams of the media data, information about a camera that captured images, display information required to display images, information about the frame rate of the video data, and information about the number of field lines of a frame in the video data. If the media data includes a 3D image, the configuration information configurer 13 may further include information about the disparity between the left and right images of the 3D image.

In step 807, the coded stream configurer 14 inserts the coded streams of the media objects included in the media data into a media data container field. The coded streams of the media objects included in the media data may be inserted in correspondence with configuration information tracks generated on a media object basis by the configuration information configurer 13.

On the other hand, if the sensory effect type detector 11 determines that the sensory effect information describes sensory effects associated with the media data in step 804, the sensory effect type detector 11 determines whether the sensory effect information describes sensory effects associated with all media objects included in the media data in step 808. If the sensory effect information describes sensory effects associated with all media objects included in the media data in step 808, the sensory effect type detector 11 transmits the sensory effect information to the configuration information configurer 13. The sensory effect type detector 11 may transmit the sensory effect type indicator together with the sensory effect information to the configuration information configurer 13.

In step 809, the configuration information configurer 13 identifies the sensory effect type indicator received from the sensory effect type detector 11, confirms that the sensory effect type indicator indicates that the sensory effect information describes sensory effects associated with all media objects included in the media data, and inserts the metadata box 753 defining the sensory effect information into the configuration information container field 750 as illustrated in FIG. 7B.

On the other hand, if the sensory effect information does not describe sensory effects associated with all media objects included in the media data in step 808, the sensory effect type detector 11 determines whether the sensory effect information describes sensory effects associated with at least one specific media object included in the media data in step 810. If the sensory effect information describes sensory effects associated with at least one specific media object included in the media data, the sensory effect type detector 11 transmits the sensory effect information to the configuration information configurer 13 and the procedure continues at step 811. The sensory effect type detector 11 may transmit the sensory effect type indicator together with the sensory effect information to the configuration information configurer 13. Meanwhile, if the sensory effect information does not describe sensory effects associated with any media object included in the media data in step 810, the configuration information configurer 13 inserts the configuration information into the configuration information container field in step 806.

In step 811, the configuration information configurer 13 identifies the sensory effect type indicator received from the sensory effect type detector 11, confirms that the sensory effect type indicator indicates that the sensory effect information describes sensory effects associated with at least one specific media object included in the media data, and inserts the metadata box 763 defining the sensory effect information into the configuration information container field 762 corresponding to the specific media object as illustrated in FIG. 7C.

Finally, the sensory effect media integration data file generator 15 generates a sensory effect media integration data file by combining the file type information received from the file type information configurer 12, the configuration information received from the configuration information configurer 13, and the coded streams received from the coded stream configurer 14 in step 812.

Especially, the sensory effect media integration data file generator 15 may detect the sensory effect type indicator received from the sensory effect type detector 11 and may generate the sensory effect media integration data file according to the sensory effect type indicator.

For example, if the sensory effect type indicator indicates that the sensory effect information describes sensory effects associated with the whole file, the sensory effect media integration data file generator 15 receives the file type field 710 having the metadata box 711 (FIG. 7A) that defines the sensory effect information inserted in it from the file type information configurer 12, receives the configuration information container field 720 having the first and second tracks 721 and 722 including configuration information about first and second media objects, respectively, inserted in it from the configuration information configurer 13, and receives the media data container field 730 having the first coded stream track 731 with the coded stream of the first media object and the second coded stream track 732 with the coded stream of the second media object from the coded stream configurer 14. Then the sensory effect media integration data file configurer 15 generates a sensory effect media integration data file including the file type field 710, the configuration information container field 720, and the media data container field 730 and outputs the sensory effect media integration data file.

If the sensory effect type indicator indicates that the sensory effect information describes sensory effects associated with all media objects included in the media data, the sensory effect media integration data file generator 15 receives the file type field 740 (FIG. 7B) having the file type information inserted in it from the file type information configurer 12, receives the configuration information container field 750 that has the first and second tracks 751 and 752 including configuration information about the first and second media objects, respectively, and the metadata box 753 defining the sensory effect information from the configuration information configurer 13, and receives the media data container field 730 having the first coded stream track 731 with the coded stream of the first media object and the second coded stream track 732 with the coded stream of the second media object from the coded stream configurer 14. Then the sensory effect media integration data file generator 15 generates a sensory effect media integration data file including the file type field 740, the configuration information container field 750, and the media data container field 730 and outputs the sensory effect media integration data file.

If the sensory effect type indicator indicates that the sensory effect information describes sensory effects associated with at least one media object included in the media data, the sensory effect media integration data file generator 15 receives the file type field 740 (FIG. 7C) having the file type information inserted in it from the file type information configurer 12, receives the configuration information container field 760 having the first track 761 with configuration information about the first media object and the second track 762 with configuration information about the second media object and the metadata box 763 defining the sensory effect information from the configuration information configurer 13, and receives the media data container field 730 having the first coded stream track 731 with the coded stream of the first media object and the second coded stream track 732 with the coded stream of the second media object from the coded stream configurer 14. Then the sensory effect media integration data file configurer 15 generates a sensory effect media integration data file including the file type field 740, the configuration information container field 760, and the media data container field 730 and outputs the sensory effect media integration data file.

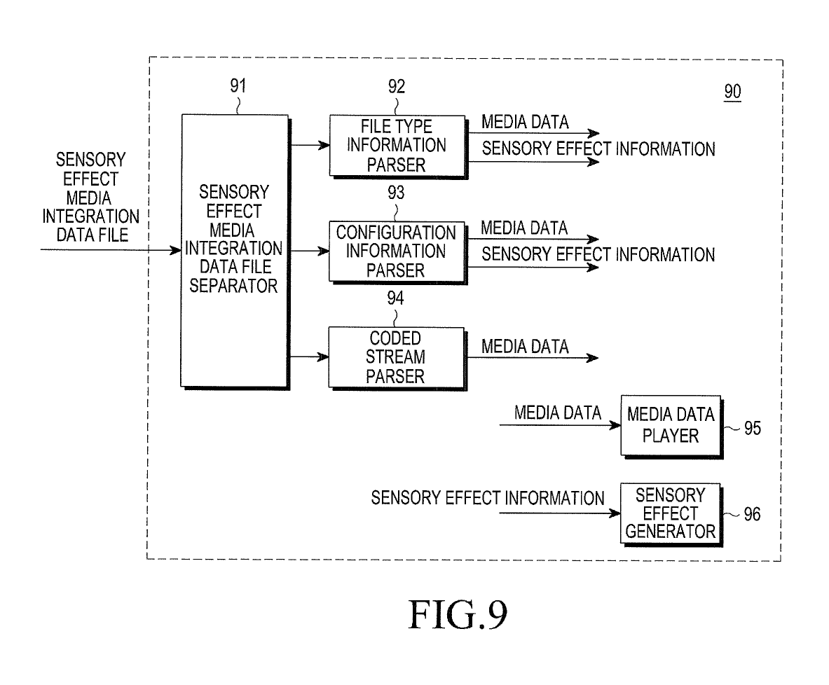

FIG. 9 illustrates an example apparatus for playing sensory effect media integration data according to an embodiment of the present invention. Referring to FIG. 9, an apparatus 90 for playing sensory effect media integration data includes a sensory effect media integration file separator 91 for receiving a sensory effect media integration file and separating a file type field, a configuration information container field, and a media data container field from the received sensory effect media integration file. The apparatus 90 for playing sensory effect media integration data further includes a file type information parser 92 for parsing information included in the file type field, a configuration information parser 93 for parsing information included in the configuration information container field, and a coded stream parser 94 for parsing information included in the media data container field.

The apparatus 90 for playing sensory effect media integration data further includes a media data player 95 for combining media data received from the file type information parser 92, the configuration information parser 93, and the coded stream parser 94 and playing the combined media data and a sensory effect generator 96 for generating sensory effects corresponding to the played media data using sensory effect information received from the file type information parser 92 and/or the configuration information parser 93.

The file type information parser 92 parses a fytp box of the file type field and checks a brand ID indicating whether the media data is general media data (i.e. video data and/or audio data) or can be played in conjunction with sensory effect information. For example, if major_brand is set to rmf1, the file type information parser 92 may determine that the media data can be played in conjunction with sensory effect information as illustrated in FIG. 6.

If the media data is general media data (i.e. video data and/or audio data), the file type information parser 92 transmits information about the file type as media data to the media data player 95.

If the media data can be played in conjunction with sensory effect information, the file type information parser 92 determines whether a sensory effect type indicator indicates that the sensory effect information describes sensory effects associated with the whole file or the media data. If the sensory effect type indicator indicates that the sensory effect information describes sensory effects associated with the whole file, the file type information parser 92 detects the sensory effect information from a metadata box inserted into the file type field and transmits the detected sensory effect information to the sensory effect generator 96.

The configuration information parser 93 parses configuration information about each media object from a track box having the configuration information and transmits the parsed configuration information as media data to the media data player 95.

In addition, the configuration information parser 93 determines whether the sensory effect type indicator indicates that the sensory effect information describes sensory effects associated with all or at least one of media objects included in the media data.

If the sensory effect type indicator indicates that the sensory effect information describes sensory effects associated with all media objects included in the media data, the configuration information parser 93 checks the sensory effect information by parsing a metadata box inserted into the configuration information container field and transmits the sensory effect information to the sensory effect generator 96. On the other hand, if the sensory effect type indicator indicates that the sensory effect information describes sensory effects associated with at least one specific media object included in the media data, the configuration information parser 93 checks the sensory effect information by parsing a metadata box inserted into (the level of) a track corresponding to the specific media object in the configuration information container field and transmits the sensory effect information to the sensory effect generator 96.

The coded stream parser 94 checks coded streams of the media objects included in the media data inserted in the media data container field and transmits the coded streams as media data to the media data player 95.

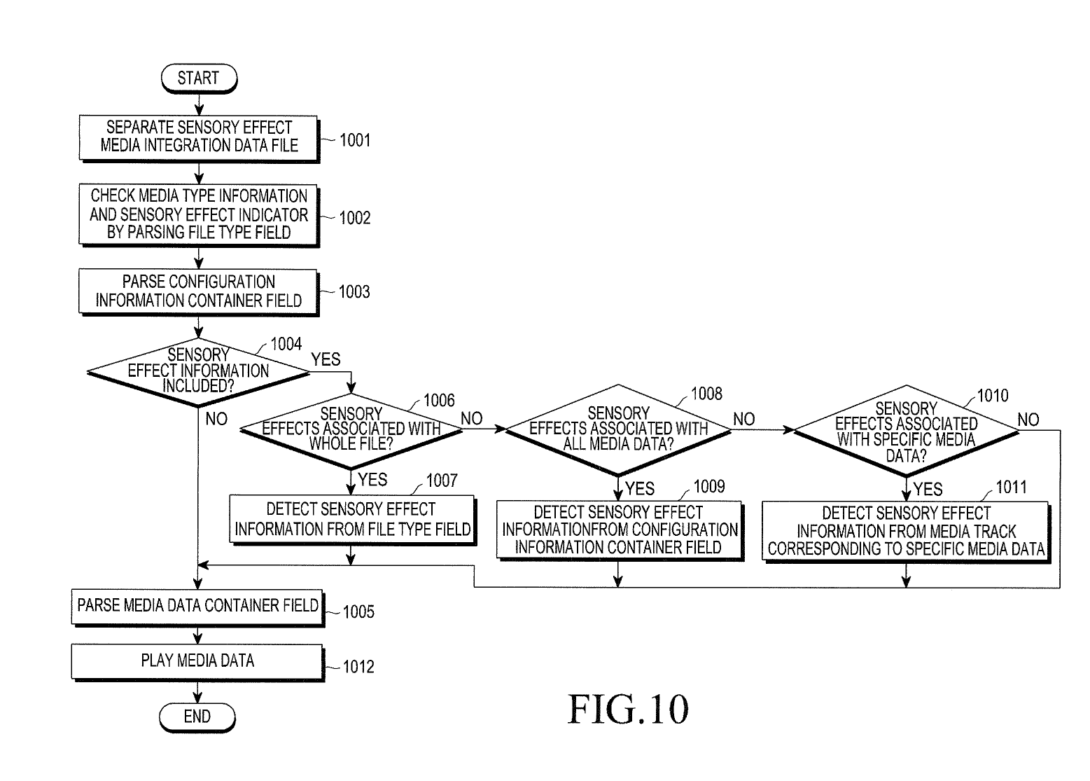

FIG. 10 illustrates an example method for playing a sensory effect media integration data file according to an embodiment of the present invention.

The operations of the above components will be described by describing the sequential steps of the method for playing a sensory effect media integration data file according to the embodiment of the present invention with reference to FIG. 10.

Referring to FIG. 10, the file type information parser 92 receives a sensory effect media integration data file, separates a file type field, a configuration information container field, and a media data container field from the received sensory effect media integration data file, and provides the file type field, the configuration information container field, and the media data container field respectively to the file type information parser 92, the configuration information parser 93, and the coded stream parser 94 in step 1001.

In step 1002, the file type information parser 92 parses a fytp box of the file type field and checks a brand ID indicating whether the media data is general media data (i.e. video data and/or audio data) or can be played in conjunction with sensory effect information. For example, if major_brand is set to rmf1, the file type information parser 92 may determine that the media data can be played in conjunction with sensory effect information as illustrated in FIG. 6.

In step 1003, the configuration information parser 93 parses configuration information about each media object from a track box having the configuration information and transmits the parsed configuration information as media data to the media data player 95.

In step 1004, the file type information parser 13 determines whether the media data can be played in conjunction with sensory effect information. If the media data can be played in conjunction with sensory effect information, the procedure continues at step 1006. If the media data is general media data (i.e. video data and/or audio data), the procedure continues at step 1005.

In step 1005, the coded stream parser 94 checks coded streams of media objects included in the media data inserted in the media data container field and transmits the coded streams as media data to the media data player 95.

In step 1006, the file type information parser 92 checks a sensory effect type indicator and determines whether the sensory effect type indicator indicates that the sensory effect information describes sensory effects associated with the whole file or the media data. If the sensory effect type indicator indicates that the sensory effect information describes sensory effects associated with the whole file, the procedure continues at step 1007. If the sensory effect type indicator does not indicate that the sensory effect information describes sensory effects associated with the whole file, the procedure continues at step 1008.

In step 1007, the file type information parser 92 detects the sensory effect information from a metadata box inserted into the file type field and transmits the detected sensory effect information to the sensory effect generator 96.

In step 1008, the configuration information parser 93 checks the sensory effect type indicator and determines whether the sensory effect type indicator indicates that the sensory effect information describes sensory effects associated with all media objects included in the media data. If the sensory effect type indicator indicates that the sensory effect information describes sensory effects associated with all media objects included in the media data, the procedure continues at step 1009. If the sensory effect type indicator does not indicate that the sensory effect information describes sensory effects associated with all media objects included in the media data, the procedure continues at step 1010.

In step 1009, the configuration information parser 93 checks the sensory effect information by parsing a metadata box inserted into the configuration information container field and transmits the sensory effect information to the sensory effect generator 96.

In step 1010, the configuration information parser 93 determines whether the sensory effect type indicator indicates that the sensory effect information describes sensory effects associated with at least one specific media object included in the media data. If the sensory effect type indicator indicates that the sensory effect information describes sensory effects associated with at least one specific media object included in the media data, the configuration information parser 93 checks the sensory effect information by parsing a metadata box inserted into a track corresponding to the specific media object in the configuration information container field and transmits the sensory effect information to the sensory effect generator 96.

If the sensory effect type indicator does riot indicate that the sensory effect information describes sensory effects associated with any specific media object included in the media data, it is determined that the sensory effect information is not included in the media data and the procedure continues at step 1012. In step 1012, the media data player 95 combines the media data received from the file type information parser 92, the configuration information parser 93, and the coded stream parser 94 and plays the combined media data. If the media data is general media data (i.e. video data and/or audio data), the sensory effect generator 96 is deactivated. On the other hand, if the media data can be played in conjunction with the sensory effect information, the sensory effect generator 96 is activated and provides sensory effects corresponding to the played media data.

As is apparent from the above description, sensory effect media integration data can be constructed in a format compatible with an international standard, the ISO Base Media File Format in the apparatus and method for constructing sensory effect media integration data. In addition, sensory effect media integration data constructed in a format compatible with an international standard, the ISO Base Media File Format can be played in the apparatus and method for playing sensory effect media integration data.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for constructing a sensory effect media integration data file, the method comprising:
inserting, in a file type field, media type information indicating a type of media data and a sensory effect indicator indicating whether sensory effect information is included or not;
inserting configuration information representing an attribute of at least one media data in a configuration information container field;
inserting a coded stream of the media data in a media data container field; and
inserting the sensory effect information in one of the file type field and the configuration information container field according to a relationship between sensory effects and the media data.

2. The method of claim 1, wherein inserting the sensory effect information comprises inserting the sensory effect information in the one of the file type field and the configuration information container field according to whether the sensory effects are associated with a whole file or the media data.

3. The method of claim 2, wherein inserting the sensory effect information comprises if the sensory effects are associated with the whole file, inserting a data box defining the sensory effect information in the file type field.

4. The method of claim 2, wherein inserting the sensory effect information comprises if the sensory effects are associated with the media data, inserting a data box defining the sensory effect information in the configuration information container field.

5. The method of claim 4, wherein the media data container field includes a media track for storing the configuration information about the at least one media data,
wherein inserting the sensory effect information comprises inserting the sensory effect information according to whether the sensory effects are associated with all or one of the media data included in the media data container field.

6. The method of claim 5, wherein inserting the sensory effect information comprises if the sensory effects are associated with all of the media data included in the media data container field, inserting a data box defining the sensory effect information in the media data container field.

7. The method of claim 5, wherein inserting the sensory effect information comprises if the sensory effects are associated with one of the media data included in the media data container field, inserting a data box defining the sensory effect information in a media track corresponding to the at least one media data.

8. An apparatus configured to construct a sensory effect media integration data file, the apparatus comprising:
a file type information configurer configured to configure file type information by detecting information about a file type of a sensory effect media integration data file from received media data;
a configuration information configurer configured to detect information about an attribute of the media data from the received media data and configure configuration information representing the attribute of the media data;
a coded stream configurer configured to detect a coded stream of the media data from the received media data and configure the coded stream of the media data;
a sensory effect type detector configured to transmit sensory effect information to one of the file type information configurer and the configuration information configurer according to a relationship between received sensory effects and the media data; and
a sensory effect media integration data file generator configured to generate a sensory effect media integration data file by combining the file type information, the configuration information, and the coded stream.

9. The apparatus of claim 8, wherein the sensory effect type detector is configured to transmit the sensory effect information to the one of the file type information configurer and the configuration information configurer according to whether the sensory effects are associated with the whole file or the media data.

10. The apparatus of claim 9, wherein if the sensory effects are associated with the whole file, the sensory effect type detector is configured to transmit the sensory effect information to the file type information configurer, the file type information configurer configured to insert a data box defining the sensory effect information in the file type field.

11. The apparatus of claim 9, wherein if the sensory effects are associated with the media data, the sensory effect type detector is configured to transmit the sensory effect information to the configuration information configurer, the configuration information configurer configured to insert a data box defining the sensory effect information in the configuration information container field.

12. The apparatus of claim 11, wherein the configuration information configurer is configured to insert the sensory effect information according to whether the sensory effects are associated with all or one of media data included in a media data container field.

13. The apparatus of claim 12, wherein if the sensory effects are associated with all of the media data included in the media data container field, the configuration information configurer is configured to insert a data box defining the sensory effect information in the media data container field.

14. The apparatus of claim 12, wherein if the sensory effects are associated with one media data included in the media data container field, the configuration information configurer is configured to insert a data box defining the sensory effect information in a media track corresponding to the one media data.

15. The apparatus of claim 8, wherein the sensory effect type detector is configured to transmit sensory effect type information indicating the relationship between the sensory effects and the media data to one of the file type information configurer and the configuration information configurer.

16. A method for playing a sensory effect media integration data file, the method comprising:
separating a file type field, a configuration information container field, and a media data container file from the sensory effect media integration data file;
detecting media type information indicating a media type and a sensory effect indicator indicating whether sensory effect information is included by parsing the file type field;
detecting configuration information about an attribute of media data by parsing the configuration information container field;
detecting a coded stream of the media data by parsing the media data container field;
playing the media data by combining the media type information, the sensory effect indicator, the configuration information, and the coded stream; and
detecting the sensory effect information from the file type field or the configuration information container field according to a relationship between sensory effects and the media data and generating sensory effects corresponding to the played media data.

17. The method of claim 16, wherein generating the sensory effect comprises if the sensory effects are associated with the whole file, detecting a data box defining the sensory effect information from the file type field.

18. The method of claim 16, wherein generating the sensory effect comprises if the sensory effects are associated with all of media data included in the media data container field, detecting a data box defining the sensory effect information from the configuration information container field.

19. The method of claim 18, wherein the configuration information container field includes a media track for storing configuration information about at least one media data, and
wherein if the sensory effects are associated with one of the media data included in the media data container field, generating the sensory effect comprises detecting a data box defining the sensory effect information from a media track corresponding to the one media data.

20. An apparatus configured to play a sensory effect media integration data file, the apparatus comprising:
a sensory effect media integration data file separator configured to separate a file type field, a configuration information container field, and a media data container file from the sensory effect media integration data file;
a file type information parser configured to detect media type information indicating a media type and a sensory effect indicator configured to indicate whether sensory effect information is included by parsing the file type field;
a configuration information parser configured to detect configuration information about an attribute of media data by parsing the configuration information container field;
a coded stream parser configured to detect a coded stream of the media data by parsing the media data container field;
a media data player configured to play the media data by combining the media type information, the sensory effect indicator, the configuration information, and the coded stream; and
a sensory effect generator configured to receive sensory effect information detected from the file type field by the file type information parser or sensory effect information detected from the configuration information container field by the configuration information parser and generate sensory effects corresponding to the played media data.
